(19) United States
(12) Patent Application Publication
(10) Pub. No.: US 2011/0320274 A1
(43) Pub. Date: Dec. 29, 2011

(54) METHOD FOR DISPLAY OFFLINE, TARGETED, INDIVIDUALLY SCHEDULED ADVERTISEMENTS IN ANY DESKTOP DISPLAY

(76) Inventor: Mandar Patil, Aundh, Pune (IN)

(21) Appl. No.: 13/254,275

(22) PCT Filed: Mar. 3, 2010
(86) PCT No.: PCT/IB10/50903

§ 371 Date: Sep. 1, 2011

(30) Foreign Application Priority Data
Mar. 4, 2009 (IN) 463/MUM/2009

(51) Int. Cl. G06Q 30/00

(52) U.S. Cl. 705/14.49

(57) ABSTRACT

The present invention relates to a method for displaying viewer targeted, offline advertisements in any desktop/display via a software installed in a user computer, displaying the said advertisements in a collapsible, movable, dynamic sized window(s) named active ad window on the said user's desktop, without interfering in any functionality of the other software or tampering and corrupting the actual core data which is in use by the user and without accessing any data of the users PC in anyway since it is a totally independent and isolated software and without the user's PC being connected to interne all the times.

### FIELD OF INVENTION

The invention relates to a method of displaying offline advertisements from an online server into the desktop even though a user's PC is not always connected to the interne.

More particularly, the invention relates to a method in which targeted, offline, individually scheduled advertisements and information are displayed in one or more collapsible, movable, dynamic sized windows which appear on the desktop screen/display.

### BACKGROUND OF THE INVENTION

The distribution of advertising via communication media such as radio, television and now computers is well established. Also, with the popularity and widespread use of computers have given rise to opportunities to advertisers to display their products and services across many homes and offices via computer screens rather than on television. There are certain similarities between computer and television in terms of their value as communication media. For instance, advertising space on certain World Wide Web sites is sold much like advertising on television stations. Advertisers can buy advertisement space at a particular World Wide Web site, the rate set by the popularity of the site. This setup is similar in nature to advertisement space as sold in periodicals, radio or television. The more popular the underlying program or time slot, the more expensive the advertising rate. At World Wide Web sites, the space takes the form of either actual space on a given display page for a given site, where an advertiser may display various graphics or text relating to a product or service, or may be of the form of a hyperlink to another World Wide Web site which contains the advertisement information.

Online advertising is a form of promotion that uses the Internet and World Wide Web for the expressed purpose of delivering marketing messages to attract customers. Examples of online advertising include contextual Advertisements on search engine results pages, banner advertisements, Rich Media Advertisements, Social network advertising, online classified advertising, advertising networks and e-mail marketing, including e-mail spam.

One major benefit of online advertising is the immediate publishing of information and content that is not limited by geography or time. To that end, the emerging area of interactive advertising presents fresh challenges for advertisers who have hitherto adopted an interruptive strategy.

The most important difference between these two Medias is the inherent nature of their association. Whereas the television is considered as leisure activity, working on computer is still stereotypically classified as work.

While advertising on the World Wide Web is known, there are problems unique to the Web for both the advertiser and the consumer when it comes to advertising in desktop software i.e. What if the user is working on the desktop but not always connected to the World Wide Web via the internet? Can such a user still be targeted by the advertisers? How can the ad display be managed in such case? For consumer or ad viewer, how can he get relevant ads? Thus, with such threshold questions and hurdles, the advertising medias' face a difficult situation considering the fact that the user would be performing certain tasks on the desktop when he is NOT connected to the World Wide Web via internet.

This also presents another unique problem to software developers such as Microsoft. Such companies would soon have to look into business models wherein ad-supported versions of desktop software are created so that the revenue can compensate their endeavors and in certain cases can be channeled back to the user by rewarding him redeemable points, which have commercial value, for viewing the advertisements. Thus, as Web advertising grows and consumer revenues shrink, there is a definite need to consider creating a method for displaying advertisements on the desktop/software.

As an emerging media of advertising, Current online advertising does not cater effectively to organized ad viewership. Also advertising offline has a lot of potential since users do spend a large amount of time on computer offline also. But at present, once any software is installed on a computer there is no mechanism is identified for the software vendor to alter or add advertisements. As the natural fallout of this, the potential to make business via displaying Advertisements in desktop software go waste.

Today, there are few options for such advertising for example floating ads, polite ads, trick banners and popup. While many users appreciate the advertisements, a system which allows the user to control both the timing and the content would be well received.

### PRIOR ART

A United States Patent No. PCT/US2006/015054 claims, “1. A system that facilitates display of content-targeted advertisements, comprising: a component that receives content-targeted advertisements and stores a subset of the advertisements on a client computer; and an advertisement display component that displays advertisements from the subset of advertisements as a function of context relating to user computer interaction, the context relating to at least one of the following: online/offline status; content of a textual interaction; or geographic or demographic information about the user.

A U.S. Pat. No. 5,959,623 claims, “A computer-implemented method for displaying informational images on a display of a user computer concurrently while said user computer executes an end user application program, the method comprising the steps of: (a) displaying images associated with said end user application program in a first portion of said user computer's display; (b) accessing, at a location remote from said user computer, a list of advertisement to be executed, each of said advertisement including data and an applet for controlling the display of at least one image associated with said data; (c) automatically identifying a first advertisement in said list; (d) dedicating a second portion of said user computer's display to display images associated with said advertisement in said second portion; (e) automatically retrieving and executing said first advertisement such that said at least one image associated with said first advertisement is displayed in said second portion of said user computer display; (f) automatically identifying a next advertisement to retrieve and execute in said list of advertisements; (g) automatically retrieving and executing said next advertisement and displaying at least one image associated with said next advertisement upon completing said executing of the advertisement prior to said next advertisement; (h) automatically repeating said steps (f) and (g) until a last advertisement in said list of advertisement is executed; and (i) performing said steps (e), (f), (g) and (h) while displaying both said images associated with said end user application program in said first portion and said images associated with said advertisement in said second portion simultaneously

A U.S. Pat. No. 6,216,141 claims, “A method for displaying a document in a desktop window on a user computer, the method comprising the steps of: connecting to a computer network from the user computer, the computer network having a plurality of server computers associated with a plurality of content providers; retrieving a channel guide including a list of content providers from the computer network for allowing a user to select and deselect two or more content providers and stories associated with the content providers, wherein the channel guide remains displayed after the user selects a content provider so that the user can select multiple content providers from the channel guide and the multiple selected content providers remain selected at the same time; storing the selections that the user made from the channel guide including which stories the user selected; reading the stored selections and obtaining an address associated with a selected content provider; retrieving the stored selections including the stories selected in the channel guide; and integrating the retrieved stories into the desktop window so that the stories and the desktop window are displayed in the same window.

### OBJECTIVES OF THE INVENTION

The above methods and systems in the prior art disclose methods which are complicated, complex and cumbersome to follow and do not provide efficient and requisite solutions to the advertising industry.

Accordingly, it is the object of the present invention to provide to advertisers a new definite, computer based media for advertising in which advertisers can organize and target ad viewership and software users can view ads, place feedbacks and earn benefits.

### SUMMARY OF THE INVENTION

Active Ad Window is a new media for computer based offline advertising in a desktop and not via an internet browser like Internet explorer, Mozilla Firefox and Netscape Navigator which are independent browsers. Active Ad Window exists independently as an ad displaying software. It can co exists with any desktop software as a part of software screen which doesn't affect the software or its functionality in anyway.

This invention presents the innovation of retrieving individually scheduled, targeted Advertisements/Images/Information/Audio/Video/ into dynamic sized and positioned windows called active ad window on the computer screen. These windows overlap some part of the application screen display. Viewership allotment is done effectively via display of targeted ads which is based on various parameters set by the advertisers like geographical area the software user is in, date wise ad display, total number of displays per day, total number of displays before the ad expires, priority wise ad display, user category wise ad display

Active Ad Window can be placed and moved on any available position on the computer screen as per the user's preference. In order to use the Active Ad Window software, user must be registered to the online web server of the software vendor. On availability of internet connections ads are downloaded from the online ad server into the active ad window software. When user logs in the software, as per the ads scheduled for each individual user, ads are displayed into the active ad windows. The user's data on the pc is not invaded in any form by the active ad window software.

In this embodiment, whenever internet connection is available, the Active Ad Window software:
(i) Downloads new Advertisements and information, from the online web server to the software's database i.e Local Active Ad Server.
(ii) Uploads ad viewer ship statistics, relevant information, ad clicks and feedback collected by the user for viewing ads, to the online Active Ad sever.

The methods define the creation of Active Ad Windows in the desktop displaying offline advertisements, and methods for selecting the ads and information to be displayed, as well as methods for accessing additional information related to the displayed advertisement images. The data pointers point to the particular advertising images, information which have been individually scheduled for display to the user. In the preferred embodiment, while working on the computer, the user can open the Active Ad Window at his own will and choice to view the adverts available for display. User can also avail larger view of Advertisements and place feedback on them.

The major benefits in this situation would be that bandwidth is used only once to download ad where as in online ads the internet bandwidth is used repetitive so very less bandwidth is required as compared with online internet ads.
2. Continuous connection to the internet is not required.
3. This information exchange process executes even when Active Ad Window software is not open actively. The exchange process occurs in the background. The information exchange process is explained in detail in the diagrammatic illustrations.
4. Retrieval of ads from software installed in the user's PC is easier that connecting to the internet to display the ad more than one time.
5. User statistics can be recorded easily in the desktop software and that can be easily uploaded to the online server. Where as in online ad it is difficult to keep a log of the viewership statistics. Advertisers can view a log of detailed viewer ship statistics. Capturing these statistics is not possible in online advertising.

The user can access such adverts at his will and choice without closing the application he is using. The Active Ad Window does not disturb the software user in anyway and the user can close the window whenever he does not wish to view the ads. The Active Ad Window feature can be applied to any desktop software as well. In this case the window would be a part of that particular software screen.

In the present invention, registration of the software will capture the user information. Due to this advertisers can target their ad display to a specific category of users For Example Doctors, Financial Analysts, students, teenagers, Lawyers, Housewives, working women.

### BRIEF DESCRIPTION OF THE DRAWINGS

Additional objects and features of the invention will be more readily apparent from the following detailed description and appended claims when taken in conjunction with the drawings, in which:

FIG. 1 illustrates a process to login to an online application and add, manage advertisement information records into the Online Active Ad Server.

FIG. 2 illustrates the activities to download new active Advertisements and information from the online active ad server to database of the software installed in the user's pc which is also called as the Local Active Ad Server.

FIG. 3 illustrates the process of displaying individually scheduled advertisements and information into the Active Ad Window and allocating reward points to the user for ad clicks and feedback.

FIG. 4 illustrates an explanatory method to upload the reward points, feedbacks, ad clicks and ad display counts from local active ad server to online active ad server.

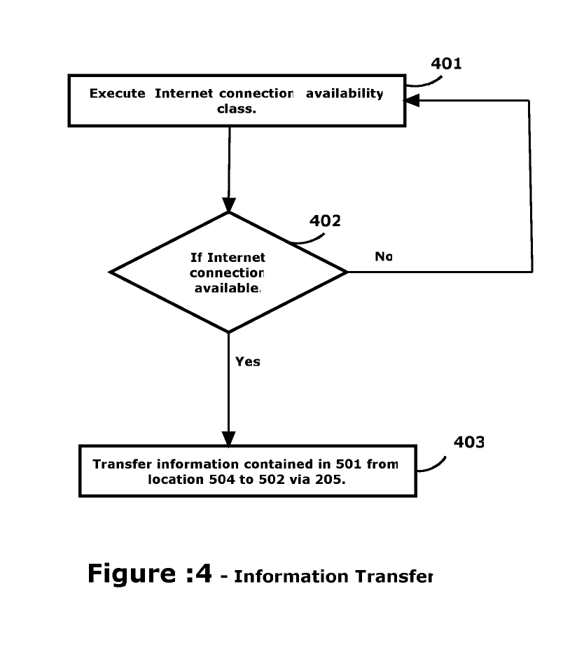

FIG. 5 is a diagrammatic illustration which describes the process of exchange of information from online active ad server to local active ad server and back from local active ad server to online active ad server.

FIG. 6 illustrates the communication between the LAAS and OLAAS database via LAAS and OLAAS source API.

FIG. 7 is a visual illustration of how the ActiveAdWindow ^{TM} looks in a desktop screen.

### DESCRIPTION OF THE INVENTION

The application program is a byte code program written in Microsoft .NET programming language.

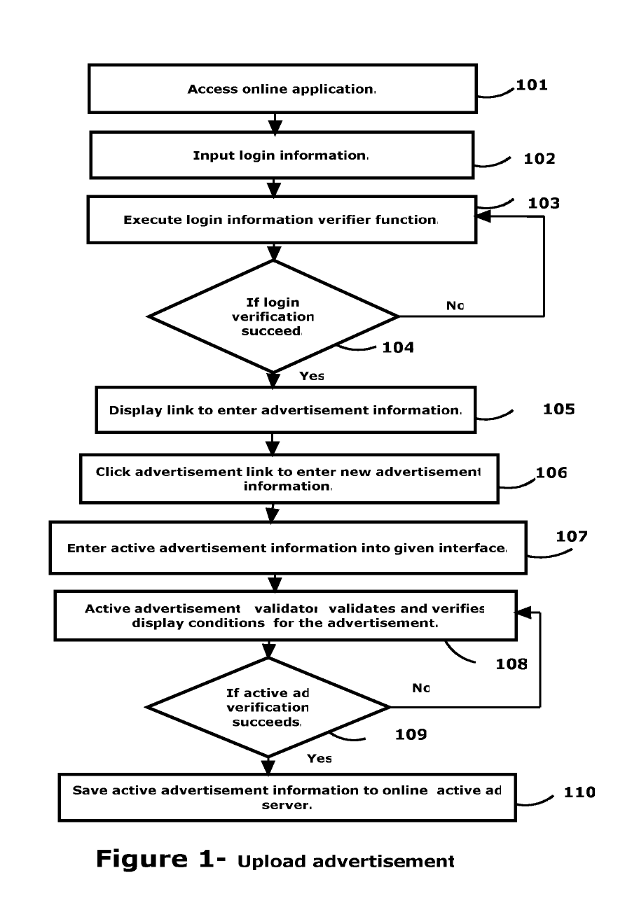

Referring to FIG. 1, User enters user name and password into 102 to access a web interface to upload the active advertisement data into online active ad server 502 via 101. User enters the login data and clicks on login button, Login verifier 103 in combination with 104 performs check for validity of the user, A link 105 will be load the interface to valid user to add advertisement information into 502. Information will include images, video audio, ad schedule details, ad upload conditions, feedback form if any provided by the advertisers. The class loader loads Advertisements the classes object into the user's address space and fetches the input fields onto the interface. User enters the advertisement information in 107 and the class utilizes the byte code program verifier to verify the integrity of the 108 method associated with each loaded object, If the method 109 is successfully verified 110 is invoked to execute the submit procedure which is typically called the method, the program is executed by the compiled program executer. In the preferred embodiment, the advertisement data may contain image/flash/audio/video/content for products or services; Audio data includes voice, music or other audio signals for playback in coordination with the image/flash. The advertisements may also be directly streamed from the online active ad server into the software. The ads can also be viewed via an ad browser application which displays ads in the Ad browser.

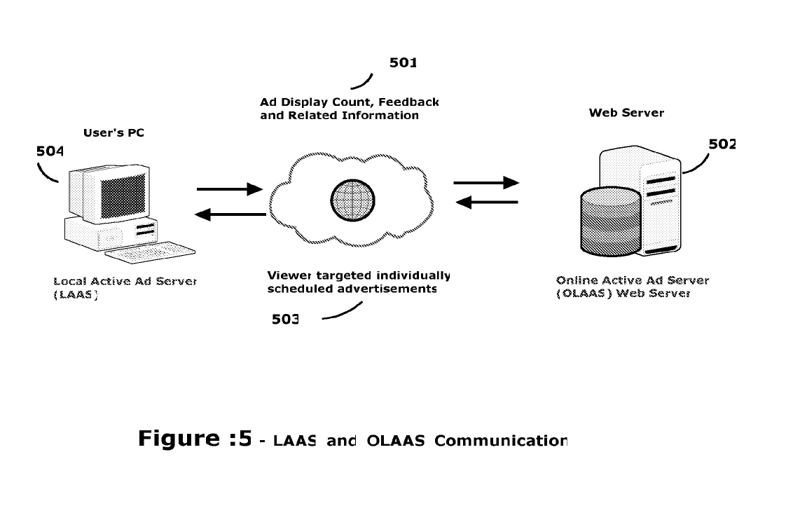

In reference to FIG. 5, a second information server 504 is shown connected via internet to an online information server 502 which includes all of the server hardware elements mentioned in the software prerequisites and includes storage space for storing advertising data structure.

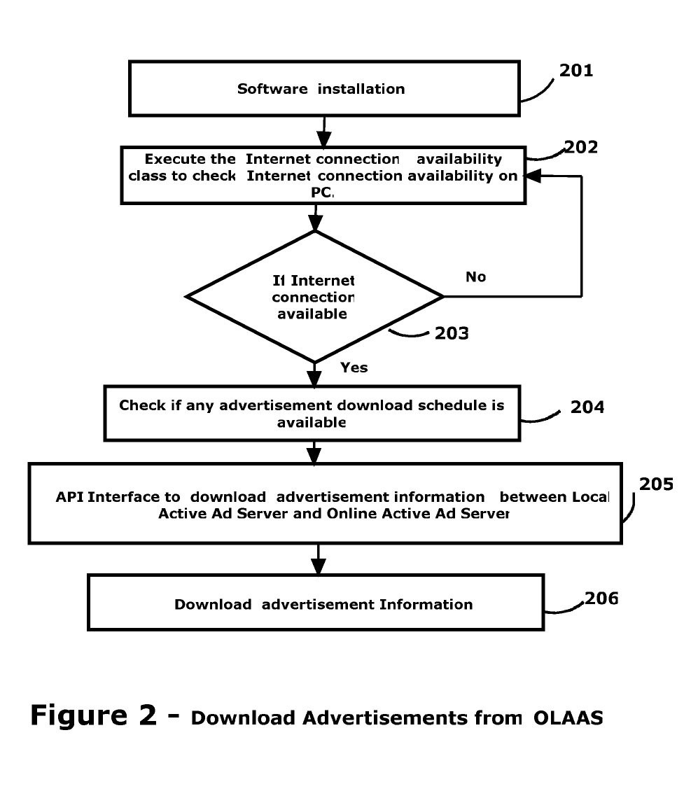

Referring to FIG. 2, an internet connection availability class 202 is evoked periodically to check if the User is connected to the internet 202 verifies the integrity of the methods associated with loaded object class and 203 to verify the internet connection availability and on the basis of result the API checks for availability of advertisements download schedule, If new advertisements are available on OLAAS, the API 205 downloads Advertisements data from 502 to 504. If internet connection breaks during the communication interface program 202 resumes downloading the data of active advertisement, when the interface program 203 detects the internet connection.

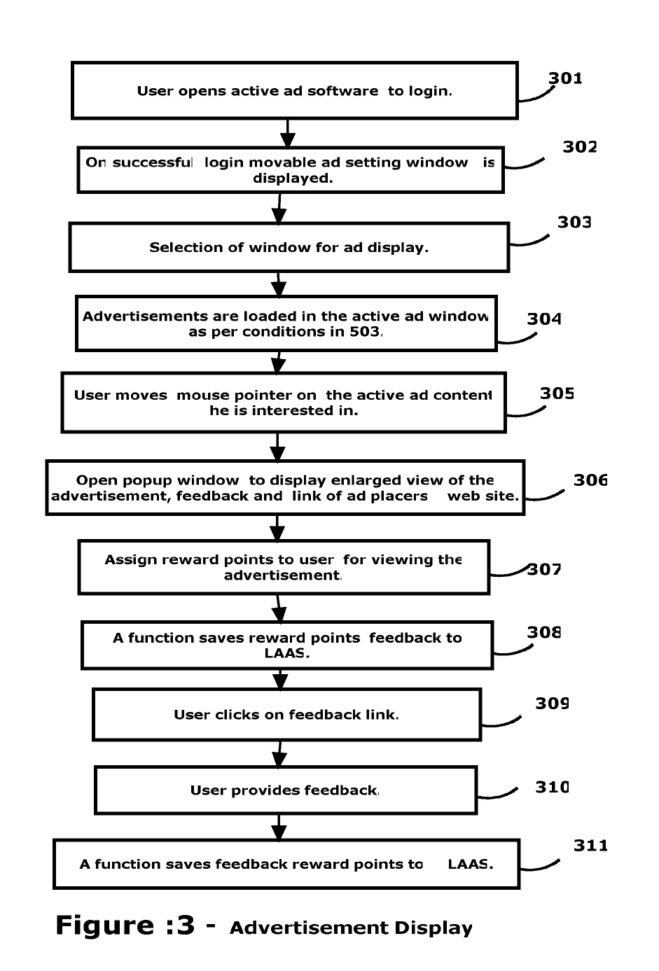

Referring to FIG. 3, software user clicks on 301 to open the ActiveAdWindow in the users desktop environment user login to ActiveAdWindow . The class 302 displays movable active ad setting window, which comprise movable ad setting window 704. User can choose multiple ad windows of different sizes, the class 303 includes methods for choosing the ad window size, the class loader loads the ad window setting class object in user's space and fetch the input setting in the interface, after successful loading the movable active ad setting window 704 will be minimized to system tray. The class 304 includes methods for displaying the ad images, flash or any associated data in the open movable ActiveAdWindow on user's desktop as per the schedule, priority set by the advertiser. The class 304 defines the operational parameters associated display parameters mentioned in 503 If the ad count in 504 is zero then the filler ad's will be displayed to the user in the ActiveAdWindow.

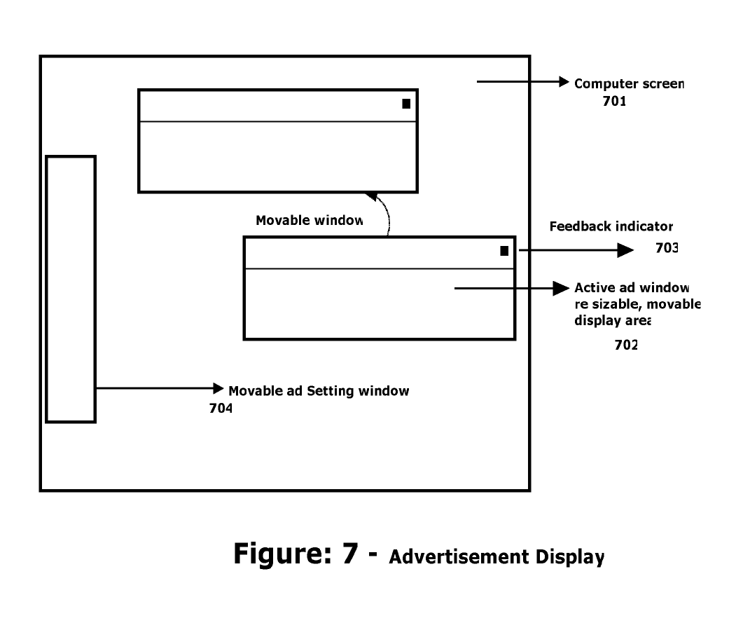

The class 304 includes methods for displaying the images, flash or any associated data in the displayed ActiveAdWindow on 702. The class 304 defines the operational parameters associated with how long image/flash are displayed on 702 as shown in FIG. 7 and includes store procedure for performing routine image/flash/video/audio presentation tasks can be invoked by the active advertisement.

If no Advertisements available on local active ad sever 504, filler ads will be displayed on window 702

Incase any ad being displayed in the ActiveAdWindow interests the user, user moves the mouse pointer on the active ad content he is interested in. It evokes a 306 method. The active ad will be displayed in enlarged popup window.

If user clicks on link 309 to place feedback to the advertisers, the feedback method is invoked to display the feedback window 310. User fills the necessary information and click on submit to store the feedback to local active ad server 504. It invokes the method 311 to save the reward points accrued by the user by submitting the feedback form.

As a first step to transfer information from 504 to 502 via 205, class 401 will execute to check availability of internet connection on User computer. In the preferred embodiment the class loader 402 is invoked upon 401, the byte code program verifier verify the integrity of all the methods associated with each loaded objects, If all the methods are successfully verified 403 is invoked to upload the users accrued points from 504 to 502 via interface 205, If internet connection breaks during this process the communication interface program 401 resumes uploading the information, when the interface program 403 detects the internet connection.

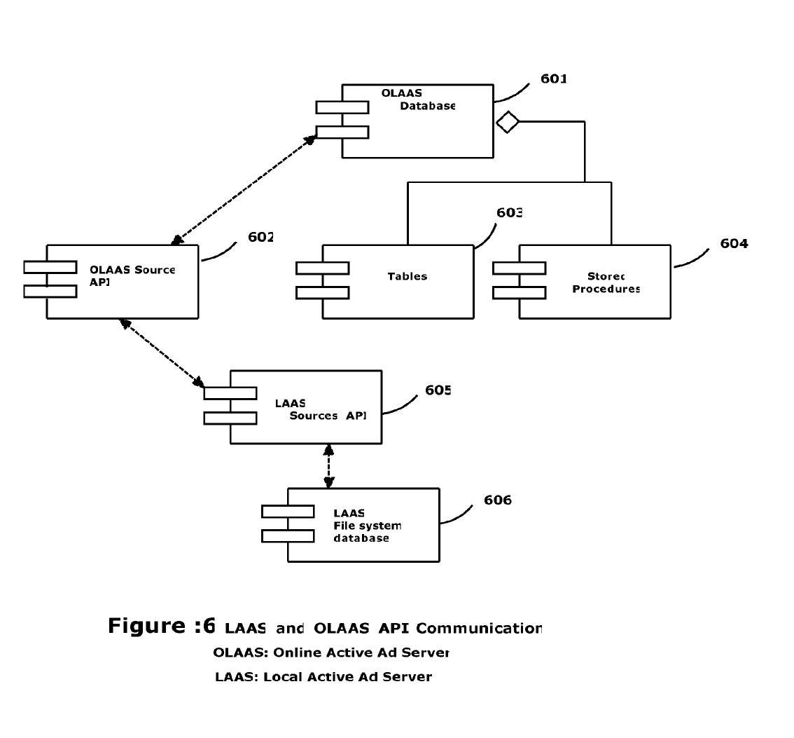

Referring to FIG. 6, it illustrates the communication between LAAS database and OLAAS database via LAAS and OLAAS sources API. The Online active ad server source API 602 communicates with OLAAS database 601 for the scheduled ads to download. The API interface provide information of ad status at LAAS database 606 to OLAAS source API 602 via LAAS source API 605 and the ad's will be downloaded from OLAAS database tables 603 by executing the procedures 604 from OLAAS database 601 to LAAS database 606 via OLAAS and LAAS API sources.

1. a method of determining eligibility of a registered advertisement viewer to receive and view advertisements; create runtime dynamic ad display scheduling; which gives the advertiser a controlled advertisement delivery mechanism, methods comprising of:
1. receiving and storing advertisement and its related information including related advertisement files, feedback questions, questionnaires, surveys and information from various advertisers at a remote server database.
2. a method of claim 1, receiving the advertiser's ad display target conditions such as registered users' age, gender, likings and preferences set in the registered profile, fixed and variable demographics, date(s) on which the ad is to be displayed, total number of ad displays per day, number of targeted users to whom the ad has to be displayed each day, total number of ad displays before the ad expires, priority of ad display, user category to whom the ad is to be display, ad display after a minimum time gap between two same advertisements, ad display to verified registered users, registered user segmentation from whom the advertisers wants to receive feedback.
3. based on the target conditions set by the advertiser as defined in claim 2, identifying the eligible target users from the registered users database, to whom the ad is to be made available for download and viewing and defining a schedule for each ad display to each particular user.
4. upon the registered user's connectivity to internet, downloading the targeted and scheduled ads and their information to the registered user's computer's local ad inbox. This local ad inbox stores all the ads received by the remote server.
5. a method wherein, selection of ads to be displayed to the user from the local ad inbox, are not only based on (a) the schedule set by the advertiser as defined in claim 2 but also on the (b) historical patterns of the times at which the computer is switched on.
6. An offline ad display mechanism of dynamically scheduled and interactive ads wherein ads and their feedback interfaces for users to provide feedback, if any, are displayed from the local ad inbox into movable, collapsible, dynamic sized interfaces which can he opened or closed at anytime by the user.
7. a method of capturing each ad click and feedback events done by the user for each ad and sending the statistics and feedback to the advertiser associated with that particular ad.
8. a method of periodically collecting and storing user's interests and preferences for ad categories of the ads he wishes to view, during the software registration and also via an interface provided to the user in the software in which he can amended his preferences anytime later, so as to enhance user's advertising experience.
9. A method wherein display of the ad can he revoked on the basis of the advertiser's request even when the ad has reached the user's local ad inbox. Whenever the user's computer is connected to the Internet after the ad cancellation from the advertiser, the instruction will be downloaded and further display of the cancelled ad will stop.
10. A method (a) to ensure data security, (b) register the software under user's unique id (c) determine the computer in which the software is installed and (d) determine user uniquely to make the aforesaid concept a complete, foolproof and commercially viable solution. These methods are explained in detail in our other filed patents bearing numbers (PCT/IB2010/052959 and PCT/IB2010/052978). These methods help to strengthen the core concept presented in this patent by ensuring that the software cannot be duplicated, hence piracy is controlled, ads are delivered only to intended registered users. The presented concept provides rewards and benefit to users so that they are encouraged to download and view the ads. Accurate accounting of individual viewership statistics and rewards has to he calculated and maintained and failure to take care of these issues will lead to an incomplete solution which cannot be commercially viable.
